(19) United States
(12) Patent Application Publication
(10) Pub. No.: US 2025/0220479 A1
(43) Pub. Date: Jul. 3, 2025

(54) Method and Apparatus Including Support for Enhanced Cross-Link Interference Reporting

(71) Applicant: Lenovo (Singapore) Pte. Limited, Singapore (SG)

(72) Inventors: Hyejung Jung, Northbrook, IL (US); Vijay Nangia, Woodridge, IL (US); Majid Ghanbarinejad, Lake Forest, CA (US)

(73) Assignee: Lenovo (Singapore) Pte. Limited, Singapore (SG)

(21) Appl. No.: 18/851,366

(22) PCT Filed: Mar. 27, 2023
(86) PCT No.: PCT/IB2023/053029

§ 371 Date: Sep. 26, 2024

Related U.S. Application Data
(60) Provisional application No. 63/325,121, filed on Mar. 29, 2022.

(51) Int. Cl. H04W 24/10; H04B 7/06; H04W 72/044

(52) U.S. Cl. CPC H04W 24/10; H04B 7/0626; H04W 72/046

(57) ABSTRACT

A method and apparatus are provided, in which a cross-link interference measurement configuration is received (202), where the cross-link interference measurement configuration includes at least one cross-link interference resource configuration. A cross-link interference resource configuration of the at least one cross-link interference resource configuration includes a cross-link interference resource and an indication of a first number of spatial information. Measurements on the cross-link interference resource are performed (204), based on the indication of the first number of spatial information.

### FIELD OF THE INVENTION

The present disclosure is directed to the management of the determination of cross-link interference measurements to be used in a measurement report, and more particularly to a determination of cross-link interference measurements specific to different spatial information, which can correspond to different spatial filters, where the measurement report can include the results of the interference measurements when each of multiple different spatial information is applied.

### BACKGROUND OF THE INVENTION

Presently, user equipment, such as wireless communication devices, communicate with other communication devices using wireless signals, such as within a network environment that can include one or more cells within which various communication connections with the network and other devices operating within the network can be supported. Network environments often involve one or more sets of standards, which each define various aspects of any communication connection being made when using the corresponding standard within the network environment. Examples of developing and/or existing standards include new radio access technology (NR), Long Term Evolution (LTE). Universal Mobile Telecommunications Service (UMTS), Global System for Mobile Communication (GSM), and/or Enhanced Data GSM Environment (EDGE).

As part of functioning within the network various operational parameters of the device may need to be managed in order for the device to more efficiently operate as intended, while allowing for information to be shared between the device and the network, and while also helping to better balance the desired performance of the device with the potential negative impact on other devices operating within the shared environment of the network.

In an effort to enhance system performance, more recent standards have looked at different forms of spatial diversity including different forms of multiple input multiple output (MIMO) systems, which involve the use of multiple antennas at each of the source and the destination of the wireless communication for multiplying the capacity of the radio link through the use of directional beams and/or multipath propagation corresponding to respective spatial information. Such a system makes increasingly possible the simultaneous transmission and reception of more than one data signal using the same radio channel.

However, different spatial information will have an associated amount of interference including co-channel and/or adjacent channel interferences corresponding to the operation of multiple base stations, and/or multiple user equipment and other environmental factors present in the vicinity of a particular user equipment, as well as along each of the various communication paths between the user equipment and the intended target of the communication. Some of the detectable interference can be more and less prevalent relative to the configuration of the device using each of a number of spatial information, such as the application of multiple different spatial filters.

The present inventors have recognized that it would be beneficial if the user equipment could evaluate for cross-link interference including a determination of an amount of interference relative to each of a number of spatial information, which in turn could be included in a measurement report and provided to a base station for use in better managing the planning of subsequent communications between the base station and the user equipment. In conjunction with determining and reporting the interference relative to the number of spatial information, it could additionally be beneficial to identify and evaluate an event trigger used in evaluating cross-link interference relative to at least some of the spatial information and sending a measurement report in response to the event trigger.

### SUMMARY

The present application provides a method in a user equipment. The method includes receiving a cross-link interference measurement configuration, where the cross-link interference measurement configuration includes at least one cross-link interference resource configuration. A cross-link interference resource configuration of the at least one cross-link interference resource configuration includes a cross-link interference resource and an indication of a first number of spatial information. Measurements on the cross-link interference resource are performed, based on the indication of the first number of spatial information.

According to another possible embodiment, a user equipment for communicating within a network is provided. The user equipment includes a transceiver for receiving a cross-link interference measurement configuration, where the cross-link interference measurement configuration includes at least one cross-link interference resource configuration. A cross-link interference resource configuration of the at least one cross-link interference resource configuration includes a cross-link interference resource and an indication of a first number of spatial information. The user equipment further includes a controller for performing measurements on the cross-link interference resource based on the indication of the first number of spatial information.

According to a further possible embodiment, a method in a network entity is provided. The method includes transmitting a cross-link interference measurement configuration, where the cross-link interference measurement configuration includes at least one cross-link interference resource configuration, where a cross-link interference resource configuration of the at least one cross-link interference resource configuration includes a cross-link interference resource and an indication of a first number of spatial information. A cross-link interference report configuration associated with the cross-link interference measurement configuration is transmitted. A measurement report based on the cross-link interference report configuration, which includes measurements performed on the cross-link interference resource based on the indication of the first number of spatial information, is then received.

According to a still further possible embodiment, a network entity is provided. The network entity includes a controller. The network entity further includes a transceiver for transmitting a cross-link interference measurement configuration, where the cross-link interference measurement configuration includes at least one cross-link interference resource configuration, where a cross-link interference resource configuration of the at least one cross-link interference resource configuration includes a cross-link interference resource and an indication of a first number of spatial information. The transceiver further transmits a cross-link interference report configuration associated with the cross-link interference measurement configuration. The transceiver further receives a measurement report based on the cross-link interference report configuration, which includes measurements performed on the cross-link interference resource based on the indication of the first number of spatial information.

These and other features, and advantages of the present application are evident from the following description of one or more preferred embodiments, with reference to the accompanying drawings.

### BRIEF DESCRIPTION OF THE DRAWINGS

FIG. 1 is a block diagram of an exemplary network environment in which the present invention is adapted to operate;

FIG. 2 is a flow diagram in a user equipment for the determination of cross-link interference measurements for use in a measurement report, which are associated with the application of multiple different spatial information:

FIG. 3 is a flow diagram in a network entity for providing a cross-link interference measurement configuration with resource and report configurations, and receiving a corresponding measurement report; and

FIG. 4 is an example block diagram of an apparatus according to a possible embodiment.

### DETAILED DESCRIPTION OF THE PREFERRED EMBODIMENT(S)

While the present disclosure is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

Embodiments provide support for the determination of cross-link interference measurements to be used in a measurement report.

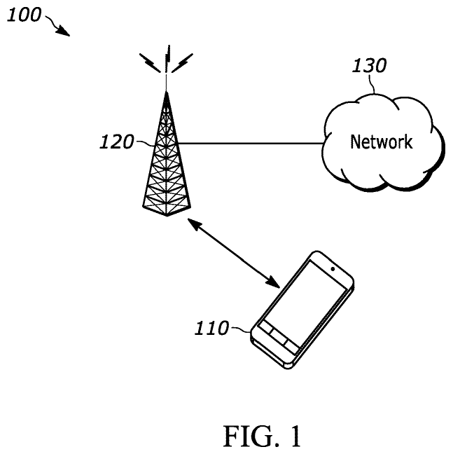

FIG. 1 is an example block diagram of a system 100 according to a possible embodiment. The system 100 can include a wireless communication device 110, such as User Equipment (UE), a base station 120, such as an enhanced NodeB (eNB) or next generation NodeB (gNB), and a network 130. In the embodiment illustrated, the network can be further associated with a management entity 175, that can serve to facilitate the control of one or more managed entities, which can correspond to a separate entity in and/or coupled to the network 130 and/or could be integrated as part of another entity, such as the wireless communication device 110, or base station 120 for managing the operation of one or more managed entities. In some instances, the management entity can be a part of an entity being managed.

The wireless communication device 110 can be a wireless terminal, a portable wireless communication device, a smartphone, a cellular telephone, a flip phone, a personal digital assistant, a personal computer, a selective call receiver, a tablet computer, a laptop computer, or any other device that is capable of sending and receiving communication signals on a wireless network.

The network 130 can include any type of network that is capable of sending and receiving wireless communication signals. For example, the network 130 can include a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 5th generation (5G) network, a 3rd Generation Partnership Project (3GPP)-based network, a satellite communications network, a high altitude platform network, the Internet, and/or other communications networks.

In Rel-16 New Radio, cross-link interference (CLI) measurement and reporting mechanisms were specified to handle co-channel and adjacent channel interferences and user equipment (UE)-to-UE and base station (BS)-to-UE interferences. However, the existing CLI measurement and reporting mechanisms do not consider potentially different interference levels measured by a UE when different spatial filters are used for interference measurements.

The present application presents enhanced CLI measurement and reporting methods considering impact of spatial filters to be used for intended communications on observed interference levels.

In Rel-16 3GPP NR, two types of CLI measurements, sounding reference signal (SRS) reference signal received power (SRS-RSRP) and CLI reference signal strength indicator (CLI-RSSI), were specified. According to 3rd Generation Partnership Project (3GPP) Technical Specification (TS) 38.215, SRS-RSRP is defined as linear average of power contributions (in Watt) of resource elements carrying SRS. SRS-RSRP shall be measured over the configured resource elements within a considered measurement frequency bandwidth in configured measurement time occasions. CLI-RSSI is defined as a linear average of the total received power (in Watts) observed only in configured orthogonal frequency division multiplexing (OFDM) symbols of a configured measurement time resource(s), in a configured measurement bandwidth from all sources, including co-channel serving and non-serving cells, adjacent channel interference, thermal noise, etc. For frequency range 1, the reference point for the measurements shall be the antenna connector of a UE. For frequency range 2, the measurements shall be done based on the combined signals from antenna elements corresponding to a given receiver branch. For frequency ranges 1 and 2, if receiver diversity is in use by the UE, the reported measurement value shall not be lower than the corresponding measurement value of any of the individual receiver branches.

SRS resources configured for SRS-RSRP measurement for CLI in a downlink (DL) bandwidth part (BWP) comprise subcarrier spacing, which is the same as the subcarrier spacing of the DL BWP. A UE is not expected to measure SRS-RSRP using a SRS-RSRP measurement resource which is not fully confined within the DL BWP. The UE is not expected to measure more than 32 SRS resources, and the UE is not expected to receive more than 8 SRS resources in a slot.

Enhanced CLI Measurement and Reporting with Spatial Differentiation

In accordance with at least one embodiment, a UE receives a cross-link interference (CLI) measurement configuration, where the CLI measurement configuration comprises one or more CLI resource configurations and each CLI resource configuration includes an indication of a number of spatial information or a number of reference resources, e.g. a number of synchronization signal and physical broadcast channel (SS/PBCH) blocks, a number of CSI-RS resources, and/or a number of Transmission Configuration Indication (TCI) states, of a reference serving cell associated with a configured CLI resource. The UE performs measurements on one or more configured CLI resources, where each CLI resource is measured based on the indicated number of spatial information (or the indicated number of reference resources). For example, if a number of synchronization signal/physical broadcast channel (SS/PBCH) blocks (SSBs) of a reference serving cell is indicated in a CLI resource configuration, as shown below in Example 1, the UE measures the configured CLI resource using at least one spatial filter used for receiving a set of SS/PBCH blocks of the reference serving cell, where the size of the set of SSBs is the same as the indicated number of SSBs.

In one implementation, a CLI resource configuration may include an indication of at least one SSB of a reference serving cell to be used by a UE for measuring a corresponding CLI resource. The UE performs measurements on the configured CLI resource based on the indicated at least one SSB of the reference serving cell, e.g. using at least one spatial filter used for receiving the indicated at least one SSB.

In another implementation, a UE selects N SSBs, where in at least some instances the N SSBs correspond to the N best SSBs (e.g. the N SSBs corresponding to the N highest SSB RSRP values) from a plurality of transmitted SSBs of a reference serving cell, where N is indicated in a CLI resource configuration. The UE can then perform measurements on a corresponding CLI resource based on the selected N SSBs.

In yet another implementation, a UE selects N TCI states (e.g. N TCI states corresponding to N lowest TCI state identities) from a plurality of configured TCI states of a reference serving cell, where N and a spatial reference (e.g. TCI state, CSI-RS resource, or SSB) are indicated in a CLI resource configuration. The UE performs measurements on a corresponding CLI resource, based on the selected N TCI states.

In another embodiment, a UE transmits at least one CLI measurement result in a measurement report, where a CLI measurement result of the at least one CLI measurement result includes a measurement quantity (e.g. RSRP, RSSI), an indication of a measured CLI resource, and an indication of spatial information that was used to obtain the measurement quantity. In an example, the indication of spatial information comprises a SSB index (as shown below in Example 3), a TCI-state identity, or a CSI-RS resource identity/index of a reference serving cell of the measured CLI resource. The UE obtains the measurement quality by using a spatial filter that was used to receive the indicated SSB, TCI-state, or the CSI-RS resource. The measurement report including the at least one CLI measurement result is sent in a RRC message. In one implementation, for periodic CLI reporting, a measurement report comprises N CLI measurement results for a given measured CLI resource, where N is the same as an indicated number of spatial information (e.g. SSBs, TCI-states, CSI-RS resources). For event triggered CLI reporting, a UE includes up to N CLI measurement results which trigger reporting for a given measured CLI resource, where N is the same as an indicated number of spatial information (e.g. SSBs, TCI-states, CSI-RS resources).

In another implementation, a UE receives an indication of a first number of spatial information. N, for performing measurements on a CLI resource in a CLI resource configuration, and an indication of a second number of spatial information, M (M is less than N), for reporting measurement results of the configured CLI resource in a measurement report configuration, as shown in Example 2. The UE includes M (or up to M) CLI measurement results for the measured CLI resource, where the UE selects M (or up to M) highest interference measurement results from N available measurement results. When M and N are not configured, the UE assumes that M and N are set to 1.

### Example 1: Modified MeasObjectCLI Information Element (IE)

The IE MeasObjectCLI specifies information applicable for SRS-RSRP measurements and/or CLI-RSSI measurements.

MeasObjectCLI information element

-- ASN1START
-- TAG-MEASOBJECTCLI-START

| | |
|---|---|
| MeasObjectCLI-r18 ::= | SEQUENCE { |
| cli-ResourceConfig-r18 | CLI-ResourceConfig-r18, |

...
}

| | |
|---|---|
| CLI-ResourceConfig-r18 ::= | SEQUENCE { |
| srs-ResourceConfig-r18 | SetupRelease {SRS-ResourceListConfigCLI- |

r18} OPTIONAL, -- Need M

| | |
|---|---|
| rssi-ResourceConfig-r18 | SetupRelease {RSSI-ResourceListConfigCLI- |

r18} OPTIONAL -- Need M
}

| | |
|---|---|
| SRS-ResourceListConfigCLI-r18 ::= | SEQUENCE (SIZE (1.. maxNrofCLI-SRS- |

Resources-r18)) OF SRS-ResourceConfigCLI-r18

| | |
|---|---|
| RSSI-ResourceListConfigCLI-r18 ::= | SEQUENCE (SIZE (1.. maxNrofCLI-RSSI- |

Resources-r18)) OF RSSI-ResourceConfigCLI-r18

| | |
|---|---|
| SRS-ResourceConfigCLI-r18 ::= | SEQUENCE { |
| srs-Resource-r18 | SRS-Resource, |
| srs-SCS-r18 | SubcarrierSpacing, |
| refServCellIndex-r18 | ServCellIndex OPTIONAL, -- Need S |
| refBWP-r18 | BWP-Id, |
| nrofSSBs-Meas-r18 | INTEGER (1..64), OPTIONAL, -- Need |

M
...
}

| | |
|---|---|
| RSSI-ResourceConfigCLI-r18 ::= | SEQUENCE { |
| rssi-ResourceId-r18 | RSSI-ResourceId-r18, |
| rssi-SCS-r18 | SubcarrierSpacing, |
| startPRB-r18 | INTEGER (0..2169), |
| nrofPRBs-r18 | INTEGER |

(4..maxNrofPhysicalResourceBlocksPlus1),

| | |
|---|---|
| startPosition-r18 | INTEGER (0..13), |
| nrofSymbols-r18 | INTEGER (1..14), |
| rssi-PeriodicityAndOffset-r18 | RSSI-PeriodicityAndOffset-r18, |
| refServCellIndex-r18 | ServCellIndex OPTIONAL, -- Need S |
| nrofSSBs-Meas-r18 | INTEGER (1..64), OPTIONAL, -- Need M |

...
}

| | |
|---|---|
| RSSI-ResourceId-r18 ::= | INTEGER (0.. maxNrofCLI-RSSI-Resources-1- |

r18)

| | |
|---|---|
| RSSI-PeriodicityAndOffset-r18 ::= | CHOICE { |
| sl10 | INTEGER(0..9), |
| sl20 | INTEGER(0..19), |
| sl40 | INTEGER(0..39), |
| sl80 | INTEGER(0..79), |
| sl160 | INTEGER(0..159), |
| sl320 | INTEGER(0..319), |
| sl640 | INTEGER(0..639), |

...
}
-- TAG-MEASOBJECTCLI-STOP
-- ASN1STOP

srs-ResourceConfig

SRS resources to be used for CLI measurements.

rssi-ResourceConfig

CLI-RSSI resources to be used for CLI measurements.

SRS-ResourceConfigCLI field descriptions

refBWP
DL BWP id that is used to derive the reference point of the SRS resource
refServCellIndex
The index of the reference serving cell that the refBWP belongs to. If this field is
absent, the reference serving cell is the primary cell (PCell).
srs-SCS
Subcarrier spacing (SCS) for SRS. Only the values 15, 30 kHz or 60 kHz (FR1), and
60 or 120 kHz (FR2) may be applicable.
profSSBs-Meas
The size of a set of best SSBs, where the UE performs measurements on the SRS
resource using a set of spatial filters that are used for receiving the set of best SSBs of
the reference serving cell.

RSSI-ResourceConfigCLI field descriptions

nrofPRBs
Allowed size of the measurement BW. Only multiples of 4 are typically allowed.
The smallest configurable number is the minimum of 4 and the width of the active DL
BWP. If the configured value is larger than the width of the active DL BWP, the UE
shall assume that the actual CLI-RSSI resource bandwidth is within the active DL
BWP.
nrofSymbols
Within a slot that is configured for CLI-RSSI measurement (see slotConfiguration),
the UE measures the RSSI from startPosition to startPosition + nrofSymbols − 1. The
configured CLI-RSSI resource generally does not exceed the slot boundary of the
reference SCS. If the SCS of configured DL BWP(s) is larger than the reference SCS,
the network configures startPosition and nrofSymbols such that the configured CLI-
RSSI resource does not exceed the slot boundary corresponding to the configured
BWP SCS. If the reference SCS is larger than SCS of configured DL BWP(s), the
network ensures startPosition and nrofSymbols are integer multiple of reference SCS
divided by configured BWP SCS.
refServCellIndex
The index of the reference serving cell. Frequency reference point of the RSSI
resource is subcarrier 0 of CRB0 of the reference serving cell. If this field is absent,
the reference serving cell is PCell.
rssi-PeriodicityAndOffset
Periodicity and slot offset for this CLI-RSSI resource. All values are in “number of
slots”. Value sl1 corresponds to a periodicity of 1 slot, value sl2 corresponds to a
periodicity of 2 slots, and so on. For each periodicity the corresponding offset is
given in number of slots.
rssi-SCS
Reference subcarrier spacing for CLI-RSSI measurement. Only the values 15, 30 kHz
or 60 kHz (FR1), and 60 or 120 kHz (FR2) are typically applicable. UE performs
CLI-RSSI measurement with the SCS of the active bandwidth part within the
configured CLI-RSSI resource in the active BWP regardless of the reference SCS of
the measurement resource.
startPosition
OFDM symbol location of the CLI-RSSI resource within a slot.
startPRB
Starting PRB index of the measurement bandwidth. For the case where the reference
subcarrier spacing is smaller than subcarrier spacing of active DL BWP(s), network
configures startPRB and profPRBs are as a multiple of active BW SCS divided by
reference SCS.
nrofSSBs-Meas
The size of a set of best SSBs, where the UE performs measurements on the RSSI
resource using a set of spatial filters that are used for receiving the set of best SSBs of
the reference serving cell.

### Example 2: ReportConfigNR Information Element

ReportConfigNR information element

-- ASN1START
-- TAG-REPORTCONFIGNR-START

| | |
|---|---|
| ReportConfigNR ::= | SEQUENCE { |
| reportType | CHOICE { |
| cli-Periodical-r16 | CLI-PeriodicalReportConfig-r16, |
| cli-EventTriggered-r16 | CLI-EventTriggerConfig-r16 |

}
}

| | |
|---|---|
| CLI-EventTriggerConfig-r16 ::= | SEQUENCE { |
| eventId-r18 | CHOICE { |
| eventIa-r18 | SEQUENCE { |
| ia-Threshold-r18 | MeasTriggerQuantityCLI-r18, |
| reportOnLeave-r18 | BOOLEAN, |
| hysteresis-r18 | Hysteresis, |
| timeToTrigger-r18 | TimeToTrigger |

}

| | |
|---|---|
| eventIb-r18 | SEQUENCE { |
| ib-Threshold-r18 | MeasTriggerQuantityCLI-r18, |
| reportOnLeave-r18 | BOOLEAN, |
| hysteresis-r18 | Hysteresis, |
| timeToTrigger-r18 | TimeToTrigger |

}

| | |
|---|---|
| eventIc-r18 | SEQUENCE { |
| ic-Threshold-r18 | MeasTriggerQuantityCLI-r18, |
| reportOnLeave-r18 | BOOLEAN, |
| hysteresis-r18 | Hysteresis, |
| timeToTrigger-r18 | TimeToTrigger |

```
    },
  ...
  },
```

| | |
|---|---|
| reportInterval-r16 | ReportInterval, |
| reportAmount-r16 | ENUMERATED {r1, r2, r4, r8, r16, r32, r64, |

infinity},

| | |
|---|---|
| maxReportCLI-r16 | INTEGER (1..maxCLI-Report-r16), |

...
}

| | |
|---|---|
| CLI-PeriodicalReportConfig-r16 ::= | SEQUENCE { |
| reportInterval-r16 | ReportInterval, |
| reportAmount-r16 | ENUMERATED {r1, r2, r4, r8, r16, r32, r64, |

infinity},

| | |
|---|---|
| reportQuantityCLI-r16 | MeasReportQuantityCLI-r16, |
| maxReportCLI-r16 | INTEGER (1..maxCLI-Report-r16), |
| nrofSSBs-Report-r18 | INTEGER (1..64), OPTIONAL, -- Need M |

...
}

| | |
|---|---|
| MeasTriggerQuantityCLI-r16 ::= | CHOICE { |
| srs-RSRP-r16 | SRS-RSRP-Range-r16, |
| cli-RSSI-r16 | CLI-RSSI-Range-r16 |

}

| | |
|---|---|
| MeasReportQuantityCLI-r16 ::= | ENUMERATED {srs-rsrp, cli-rssi} |

-- TAG-REPORTCONFIGNR-STOP
-- ASN1STOP

CLI-EventTriggerConfig field descriptions

ia-Threshold, ib-Threshold, ic-Threshold
Threshold values associated with the selected trigger quantity (e.g. SRS-RSRP, CLI-
RSSI) to be used in CLI measurement report triggering condition for event ia, ib, and
ic, respectively.
eventId
Choice of CLI event triggered reporting criteria.
maxReportCLI
Max number of CLI measurement resources to include in the measurement report.
reportAmount
Number of measurement reports.
reportOnLeave
Indicates whether or not the UE shall initiate the measurement reporting procedure
when the leaving condition is met for a CLI measurement resource in
srsTriggeredList or rssiTriggeredList.
timeToTrigger
Time during which specific criteria for the event needs to be met in order to trigger a
measurement report.

CLI-PeriodicalReportConfig field descriptions

maxReportCLI
Max number of CLI measurement resources to include in the measurement report.
reportAmount
Number of measurement reports.
reportQuantityCLI
The CLI measurement quantities to be included in the measurement report.
nrofSSBs-Report
The size of the subset of SSBs of the set of best SSBs, where the UE performs
measurements on the CLI resource using a set of spatial filters that are used for
receiving the set of best SSBs of the reference serving cell and the UE reports the
subset of measurement results corresponding to the subset of SSBs. The subset of
measurement results is selected in decreasing order.

### Example 3: Modified MeasResults Information Element

| | |
|---|---|
| MeasResultCLI-r18 ::= | SEQUENCE { |
| measResultListSRS-RSRP-r18 | MeasResultListSRS-RSRP-r18 OPTIONAL, |
| measResultListCLI-RSSI-r18 | MeasResultListCLI-RSSI-r18 OPTIONAL |

}

| | |
|---|---|
| MeasResultListSRS-RSRP-r18 ::= | SEQUENCE (SIZE (1.. maxCLI-Report-r16)) OF |

MeasResultSRS-RSRP-r18

| | |
|---|---|
| MeasResultSRS-RSRP-r18 ::= | SEQUENCE { |
| srs-ResourceId-r18 | SRS-ResourceId, |
| ssb-Index-r18 | SSB-Index, |
| srs-RSRP-Result-r18 | SRS-RSRP-Range-r18 |

}

| | |
|---|---|
| MeasResultListCLI-RSSI-r18 ::= | SEQUENCE (SIZE (1.. maxCLI-Report-r18)) OF |

MeasResultCLI-RSSI-r18

| | |
|---|---|
| MeasResultCLI-RSSI-r18 ::= | SEQUENCE { |
| rssi-ResourceId-r18 | RSSI-ResourceId-r18, |
| ssb-Index-r18 | SSB-Index, |
| cli-RSSI-Result-r18 | CLI-RSSI-Range-r18 |

}

In one embodiment, a UE receives a CLI report configuration, where the CLI report configuration includes an event-trigger based measurement report configuration and a condition triggering for the UE to send a measurement report, which is based on N measurement results for a given CLI resource, where each of the N measurement results for the CLI resource is associated with each of N spatial information. For example, each of the N measurement results can be obtained by using a spatial filter that is used to receive a corresponding SSB of the N SSBs of a reference serving cell of the CLI resource. The N spatial information (e.g. N SSBs, N TCI-states, N CSI-RS resources) may be configured via a CLI measurement configuration. Alternatively, the UE may determine the N spatial information by selecting N SSBs with the N highest synchronization signal (SS)-RSRP values.

In one implementation, a UE sends a measurement report for an entering condition of an event being satisfied, where any M measurement results of the N measurement results for a CLI resource indicate the interference level is higher than a first configured value. Additionally, the UE can be configured to send a measurement report for a leaving condition of the event being satisfied, where all of the N measurement results for the CLI resource indicate the interference level is lower than a second configured value. These conditions can be implemented as Event Ia in Example 5. In an example, the UE can include M or more measurement results for the CLI resource indicating that the interference level is higher than the first configured value in the measurement report. The value M is predefined or configured in a CLI report configuration.

In another implementation, a UE sends a measurement report for an entering condition of an event being satisfied, where all of the N measurement results for a CLI resource indicate that the interference level is higher than a first configured value. Additionally, the UE can be configured to send a measurement report for a leaving condition of the event being satisfied, where any of the N measurement results for the CLI resource indicates that the interference level is lower than a second configured value. This can be implemented as Event Ib in Example 5.

In yet another implementation, a UE receives an indication of at least one reference spatial information (e.g. a serving SSB of a reference serving cell, an active TCI-state of the reference serving cell) for a CLI resource. The UE sends a measurement report for an entering condition of an event being satisfied, where any measurement result corresponding to the at least one reference spatial information for the CLI resource indicates that the interference level is higher than a first configured value. Additionally, the UE can be configured to send a measurement report for a leaving condition of the event being satisfied, where all of measurement results corresponding to the at least one reference spatial information for the CLI resource indicates that the interference level is lower than a second configured value.

In an implementation, a UE sends a measurement report including a plurality of measurement results corresponding to a plurality of spatial information for a CLI resource, where the plurality of measurement results comprise a reference measurement result corresponding to a reference spatial information and one or more differential measurement quantities with respect to the reference measurement result corresponding to non-reference spatial information, as shown in Example 4.

In another embodiment, a UE receives a CLI report configuration, where the CLI report configuration includes an event-trigger based measurement report configuration and a condition(s) triggering for the UE to send a measurement report is based on each measurement result of N measurement results for a given CLI resource. For example, as shown in Event Ic of Example 5, event triggering is individually assessed for each of the N measurement results. Further, measurement results for the same CLI resource but for different spatial information are counted separately for the number of results included in the measurement report.

### Example+Modified MeasResults Information Element

| | |
|---|---|
| MeasResultCLI-r18 ::= | SEQUENCE { |
| measResultListSRS-RSRP-r18 | MeasResultListSRS-RSRP-r18 OPTIONAL, |
| measResultListCLI-RSSI-r18 | MeasResultListCLI-RSSI-r18 OPTIONAL |

}

| | |
|---|---|
| MeasResultListSRS-RSRP-r18 ::= | SEQUENCE (SIZE (1.. maxCLI-Report-r16)) OF |

MeasResultSRS-RSRP-r18

| | |
|---|---|
| MeasResultSRS-RSRP-r18 ::= | SEQUENCE { |
| srs-ResourceId-r18 | SRS-ResourceId, |
| ssb-IndexList-r18 | SEQUENCE (SIZE (1.. maxCLI- |

ResultPerResource-r16)) OF SSB-Index,

| | |
|---|---|
| srs-RSRP-RefResult-r18 | SRS-RSRP-Range-r18, |
| srs-RSRP-DiffResultList-r18 | SEQUENCE (SIZE (1.. maxCLI- |

ResultPerResource-r16-1)) OF SRS-RSRP-DiffRange-r18
}

| | |
|---|---|
| MeasResultListCLI-RSSI-r18 ::= | SEQUENCE (SIZE (1.. maxCLI-Report-r18)) OF |

MeasResultCLI-RSSI-r18

| | |
|---|---|
| MeasResultCLI-RSSI-r18 ::= | SEQUENCE { |
| rssi-ResourceId-r18 | RSSI-ResourceId-r18, |
| ssb-IndexList-r18 | SEQUENCE (SIZE (1.. maxCLI- |

ResultPerResource-r16)) OF SSB-Index,

| | |
|---|---|
| cli-RSSI-RefResult-r18 | CLI-RSSI-Range-r18, |
| cli-RSSI-DiffResultList-r18 | SEQUENCE (SIZE (1.. maxCLI- |

ResultPerResource-r16-1)) OF CLI-RSSI-DiffRange-r18
}

### Example 5: Event Ix (Interference Becomes Higher than Threshold)

### Event Ia

The UE shall:
1>consider the entering condition for this event to be satisfied when condition Ia-1, as specified below, is fulfilled;

1>consider the leaving condition for this event to be satisfied when condition Ia-2, as specified below, is fulfilled.

### Inequality Ia-1 (Entering Condition)

Mi,n-Hys>Thresh for M number of n values among N measurement results for the CLI resource

### Inequality Ia-2 (Leaving Condition)

Mi,n+Hys<Thresh for all n among N measurement results for the CLI resource

### Event Ib

The UE shall:
1>consider the entering condition for this event to be satisfied when condition Ib-1, as specified below, is fulfilled;
1>consider the leaving condition for this event to be satisfied when condition Ib-2, as specified below, is fulfilled.

### Inequality Ib-1 (Entering Condition)

Mi,n-Hys>Thresh for all n for N measurement results for the CLI resource

### Inequality Ib-2 (Leaving Condition)

Mi,n+Hys<Thresh for any n among N measurement results for the CLI resource

### Event Ic

The UE shall:
1>consider the entering condition for this event to be satisfied when condition Ic-1, as specified below, is fulfilled;
1>consider the leaving condition for this event to be satisfied when condition Ic-2, as specified below, is fulfilled.

### Inequality Ic-1 (Entering Condition)

$$Mi , n - Hys > Thresh$$

### Inequality Ic-2 (Leaving Condition)

$$Mi , n + Hys < Thresh$$

The variables in the formula are defined as follows:
Mi,n is the measurement result of the interference associated with the n-th selected (or configured) SSB with the SSB index sₙ, not taking into account any offsets, where n ∈ {1, 2, . . . , N}. N is the number of measurement results corresponding to the set of selected (or configured) SSBs, and sₙ, is the SSB index of the n-th selected (or configured) SSB from the set S={s₁, s₂, . . . , s_{N}} and S is the set of SSB indices corresponding to the N selected (or configured) SSBs.
Hys is the hysteresis parameter for this event (i.e. hysteresis as defined within reportConfigNR for this event).
Thresh is the threshold parameter for this event (i.e. ia-Threshold, ib-Threshold. and ic-Threshold as defined within reportConfigNR for this event).
Mi,n, Thresh are expressed in dBm.
Hys is expressed in dB.

In an implementation, a UE shall
1> for each measId included in the measIdList within VarMeasConfig:
   2> if the reportType for the associated reportConfig is cli-Periodical or cli-EventTriggered:
      3> perform the corresponding measurements associated to CLI measurement resources indicated in the concerned measObjectCLI:
   2> perform the evaluation of reporting criteria.

Further, if access stratum (AS) security has been activated successfully, the UE shall:
1> for each measId included in the measIdList within VarMeasConfig:
   2> if the reportType is set to cli-EventTriggered and if the entry condition applicable for this event, i.e. the event corresponding with the eventId of the corresponding reportConfig within VarMeasConfig, is fulfilled for one or more applicable CLI measurement resources for all measurements after layer 3 filtering taken during timeToTrigger defined for this event within the VarMeasConfig, while the VarMeasReportList does not include a measurement reporting entry for this measId (a first CLI measurement resource triggers the event):
      3> include a measurement reporting entry within the VarMeasReportList for this measId;
      3> set the number OfReportsSent defined within the VarMeas ReportList for this measId to 0;
      3> include the concerned CLI measurement resource(s) in the cli-TriggeredList defined within the VarMeasReportList for this measId;
      3> initiate the measurement reporting procedure;
   2> else if the reportType is set to cli-EventTriggered and if the entry condition applicable for this event, i.e. the event corresponding with the eventid of the corresponding reportConfig within VarMeasConfig, is fulfilled for one or more CLI measurement resources not included in the cli-TriggeredList for all measurements after layer 3 filtering taken during timeToTrigger defined for this event within the VarMeasConfig (a subsequent CLI measurement resource triggers the event):
      3> set the number OfReportsSent defined within the VarMeas ReportList for this measId to 0;
      3> include the concerned CLI measurement resource(s) in the cli-TriggeredList defined within the VarMeasReportList for this measId;
      3> initiate the measurement reporting procedure:
   2> else if the reportType is set to cli-EventTriggered and if the leaving condition applicable for this event is fulfilled for one or more of the CLI measurement resources included in the cli-TriggeredList defined within the VarMeasReportList for this measId for all measurements after layer 3 filtering taken during timeToTrigger defined within the VarMeasConfig for this event:
      3>remove the concerned CLI measurement resource(s) in the cli-TriggeredList defined within the VarMeasReportList for this measId;
      3> if reportOnLeave is set to true for the corresponding reporting configuration:
         4> initiate the measurement reporting procedure;
      3> if the cli-TriggeredList defined within the VarMeasReportList for this measId is empty:
         4>remove the measurement reporting entry within the VarMeasReportList for this measId;
         4>stop the periodical reporting timer for this measId, if running; 2> if reportType is set to cli-Periodical and if a (first) measurement result is available:
   3> include a measurement reporting entry within the VarMeasReportList for this measId;
      3> set the number OfReportsSent defined within the VarMeasReportList for this measId to 0;
      3> initiate the measurement reporting procedure, immediately after the quantity to be reported becomes available for at least one CLI measurement resource;
1> if there is at least one applicable CLI measurement resource to report:
   2> if the reportType is set to cli-EventTriggered or cli-Periodical:
      3> set the measResultCLI to include the most interfering SRS resources or most interfering CLI-RSSI resources and and the corresponding SSB of the reference serving cell up to maxReportCLI in accordance with the following:
         4> if the reportType is set to cli-EventTriggered:
         5> if trigger quantity is set to srs-RSRP i.e. ic-Threshold is set to srs-RSRP:
         6> include the SRS resource included in the cli-TriggeredList as defined within the VarMeasReportList for this measId;
         5> if trigger quantity is set to cli-RSSI i.e. ic-Threshold is set to cli-RSSI:
         6> include the CLI-RSSI resource included in the cli-TriggeredList as defined within the VarMeasReportList for this measId;
         4> else:
         5> if reportQuantityCLI is set to srs-rsrp:
         6> include the applicable SRS resources for which the new measurement results became available since the last periodical reporting or since the measurement was initiated or reset;
         5> else:
         6> include the applicable CLI-RSSI resources for which the new measurement results became available since the last periodical reporting or since the measurement was initiated or reset;
         4> for each SRS resource that is included in the measResultCLI:
         5> include the srs-ResourceId:
         5> set srs-RSRP-Result to include the layer 3 filtered measured results in decreasing order, i.e. the most interfering SRS resource and the corresponding SSB of the reference serving cell is included first;
         4> for each CLI-RSSI resource that is included in the measResultCLI:
         5> include the rssi-Resourceld;
         5> set cli-RSSI-Result to include the layer 3 filtered measured results in decreasing order, i.e. the most interfering CLI-RSSI resource and the corresponding SSB of the reference serving cell is included first;
1>increment the numberOfReportsSent as defined within the VarMeasReportList for this measId by 1;
1>stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measid:
1> else:
   2> if the reportType is set to cli-Periodical:
      3>remove the entry within the VarMeasReportList for this measId;
      3>remove this measId from the measIdList within VarMeasConfig;
1> else:
   2>submit the MeasurementReport message to lower layers for transmission, upon which the procedure ends
      Antenna Panel, Antenna Port, Quasi-collocation, TCI state, and Spatial Relation

In some embodiments, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or multiple spatial directions.

In some embodiments, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices such as a central unit (CU), it can be used for signaling or local decision making.

In some embodiments, an antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on the implementation, a “panel” can have at least one of the following functionalities as an operational role of Unit of antenna group to control its Tx beam independently. Unit of antenna group to control its transmission power independently, Unit of antenna group to control its transmission timing independently. The “panel” may be transparent to another node (e.g., next hop neighbour node). For certain condition(s), another node or network entity can assume the mapping between device's physical antennas to the logical entity “panel” may not be changed. For example, the condition may include until the next update or report from device or comprise a duration of time over which the network entity assumes there will be no change to the mapping. Device may report its capability with respect to the “panel” to the network entity. The device capability may include at least the number of “panels”. In one implementation, the device may support transmission from one beam within a panel: with multiple panels, more than one beam (one beam per panel) may be used for transmission. In another implementation, more than one beam per panel may be supported/used for transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties:
‘QCL-TypeA’: {Doppler shift. Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure). PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission, i.e. the device would need to form beams for directional transmission. A QCL-TypeD between two reference signals A and B, the reference signal A is considered to be spatially co-located with reference signal B and the device may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target references signal (RS) of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between an integrated access backhaul-distributed unit (IAB-DU) of a parent IAB node and an integrated access backhaul-mobile termination (IAB-MT) of a child IAB node). In some of the embodiments described, a TCI state comprises at least one source RS to provide a reference (device assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception of the reference signal (RS) (e.g., DL RS such as SSB/CSI-RS). In another example, the device may transmit the target transmission with the same spatial domain transmission filter used for the transmission of the RS (e.g., UL RS such as SRS). A device can receive a configuration of a plurality of spatial relation information configurations for a serving cell for transmissions on the serving cell.

In various wireless network deployment scenarios, cross-link interference (CLI) including co-channel and/or adjacent channel interferences and user equipment (UE)-to-UE and/or base station (BS)-to-UE interferences can occur. With multiple beam-based cell operation, UE-to-UE, inter-cell and/or intra-cell interferences may be effectively mitigated with proper selections of a served UE, a serving beam, and a corresponding receive beam at the UE.

This present application presents enhanced CLI measurement and reporting methods suitable for multiple beam-based cell and UE operations.

Enhanced CLI Measurement and Reporting with Spatial Differentiation
A CLI resource configuration includes an indication of a number of spatial information (e.g. SSBs) of a reference cell of a configured CLI resource. A UE measures the configured CLI resource based on the indicated number of spatial information, e.g. using at least one spatial filter used for receiving a set of SSBs of the reference serving cell, where the size of the set is same as the indicated number of SSBs.
A UE transmits at least one CLI measurement result in a measurement report, where a CLI measurement result of the at least one CLI measurement result includes a measurement quantity (e.g. RSRP, RSSI), an indication of a measured CLI resource, and an indication of spatial information that was used to obtain the measurement quantity.

### Enhanced Event-Trigger Based CLI Reporting

A UE evaluates at least one condition of an event triggering transmission of a measurement report based on a set of measurement quantities for a cross-link interference (CLI) resource, where the set of measurement quantities are generated based on a set of spatial information.
A UE receives an indication of at least one reference spatial information (e.g. a serving SSB of a reference serving cell, an active TCI-state of the reference serving cell) for a CLI resource. The UE sends a measurement report for an entering condition of an event being satisfied, where any measurement result corresponding to the at least one reference spatial information for the CLI resource indicates the interference level higher than a first configured value. Additionally, the UE can be configured to send a measurement report for a leaving condition of the event being satisfied, where all of measurement results corresponding to the at least one reference spatial information for the CLI resource indicate the interference level lower than a second configured value.
In a measurement report, a plurality of measurement quantities comprise a reference measurement quantity and one or more differential measurement quantities with respect to the reference measurement quantity.

In Rel-16 New Radio, CLI measurement and reporting mechanisms were specified to handle co-channel and adjacent channel interferences and UE-to-UE and BS-to-UE interferences. However, the existing CLI measurement and reporting mechanisms do not allow a UE to report potentially different interference levels measured by the UE, when different spatial filters are used for interference measurements.

At least one aspect of the presently proposed CLI measurement and reporting method enables a UE to report the impact of spatial filters to be used by the UE for intended communications on observed interference levels. Accordingly, a network entity can use the reported information for interference handling with proper scheduling of UEs and corresponding serving beams.

In at least one aspect of the presently proposed event-triggering based interference reporting method, a network entity configures a UE with a triggering condition for CLI measurement reporting such that the UE reports the interference when one or more spatial filters used by the UE for receiving one or more serving beams observes high level of interference.

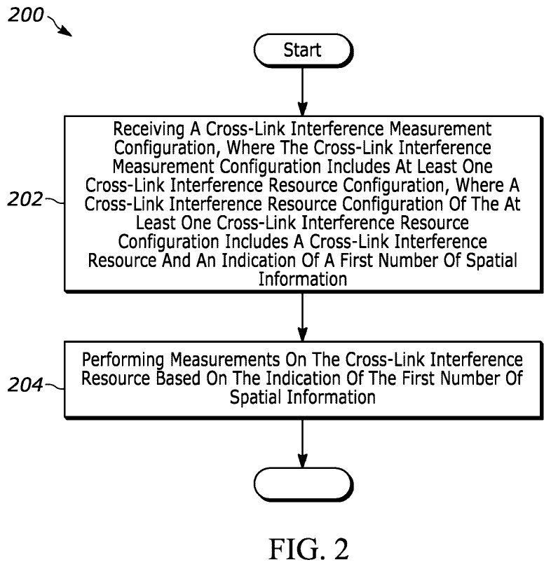

FIG. 2 illustrates a flow diagram 200 of a method in a user equipment. The method includes receiving 202 a cross-link interference measurement configuration, where the cross-link interference measurement configuration includes at least one cross-link interference resource configuration. A cross-link interference resource configuration of the at least one cross-link interference resource configuration includes a cross-link interference resource and an indication of a first number of spatial information. Measurements on the cross-link interference resource are performed 204, based on the indication of the first number of spatial information.

In some instances, each spatial information can be associated with a reference serving cell of the cross-link interference resource, wherein the cross-link interference resource can be determined based on at least one parameter of the reference serving cell. In some of these instances, each spatial information can comprise a synchronization signal/physical broadcast channel block, a transmission configuration indicator-state, or a channel state information-reference signal resource of the reference serving cell.

In some instances, performing measurements can comprise generating a same number of measurement results for the cross-link interference resource as the indication of the first number of spatial information, wherein each measurement result corresponds to a different respective one of the first number of spatial information. In some of these instances, each measurement result for the cross-link interference resource can comprise an indication of the cross-link interference resource, a measurement quantity, and an indication of the corresponding different respective one of the first number of spatial information.

In some instances, the method can further include receiving a cross-link interference report configuration associated with the cross-link interference measurement configuration, and transmitting a measurement report based on the cross-link interference report configuration. In some of these instances, the indication of the first number of spatial information, upon which the performing measurements on the cross-link interference resource is based, can include a first number of different spatial filters being used for interference measurements, which produce potentially different interference levels measured by the user equipment which can be included in the measurement report. Further, the cross-link interference report configuration can comprise an indication of a second number of spatial information to be selected from the first number of spatial information, wherein the second number is less than or equal to the first number, wherein transmitting the measurement report can include transmitting the measurement report comprising measurement results for the second number of spatial information for the cross-link interference resource. In some of these instances, the second number of spatial information to be selected from the first number of spatial information can include an indication of spatial information for which the corresponding measurement results had the highest amount of interference from the measurements performed relative to the first number of different spatial filters.

In some instances, the transmitting of the measurement report based on the cross-link interference report configuration can be transmitted in a radio resource control message. In some instances, the transmitting of the measurement report can include periodic cross-link interference reporting. In some instance, the transmitting of the measurement report can include event triggered cross-link interference reporting.

In some instances, the method can further include receiving a set of spatial information corresponding to the first number of spatial information.

In some instances, the method can further include selecting a set of spatial information corresponding to the first number of spatial information, wherein selecting the set of spatial information can comprise selecting the best first number of spatial information from all of the available possible spatial information, based upon a predefined selection criteria. In some of these instances, the predefined selection criteria can correspond to a selection of one or more synchronization signal/physical broadcast channel blocks having a highest reference signal received power. In other of these instances, the predefined selection criteria can correspond to a selection of one or more transmission configuration indicator states having a lowest transmission configuration indicator state identity.

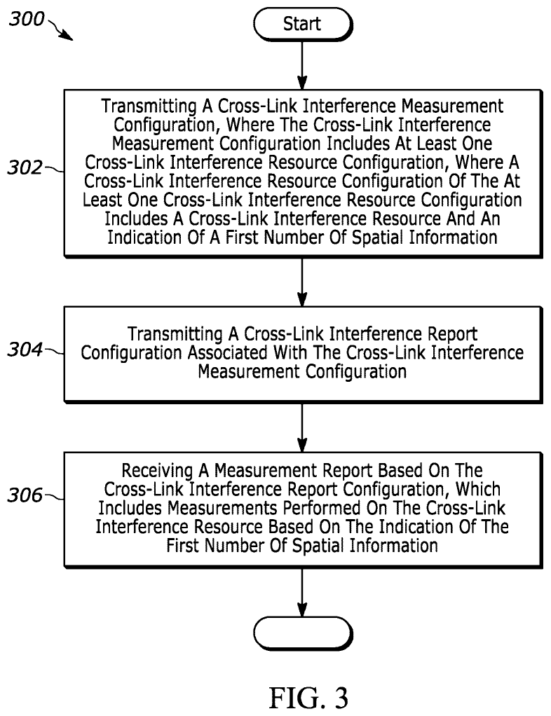

FIG. 3 illustrates a flow diagram 300 of a method in a network entity. The method includes transmitting 302 a cross-link interference measurement configuration, where the cross-link interference measurement configuration includes at least one cross-link interference resource configuration, where a cross-link interference resource configuration of the at least one cross-link interference resource configuration includes a cross-link interference resource and an indication of a first number of spatial information. A cross-link interference report configuration associated with the cross-link interference measurement configuration is then transmitted 304. A measurement report based on the cross-link interference report configuration, which includes measurements performed on the cross-link interference resource based on the indication of the first number of spatial information, is then received 306.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

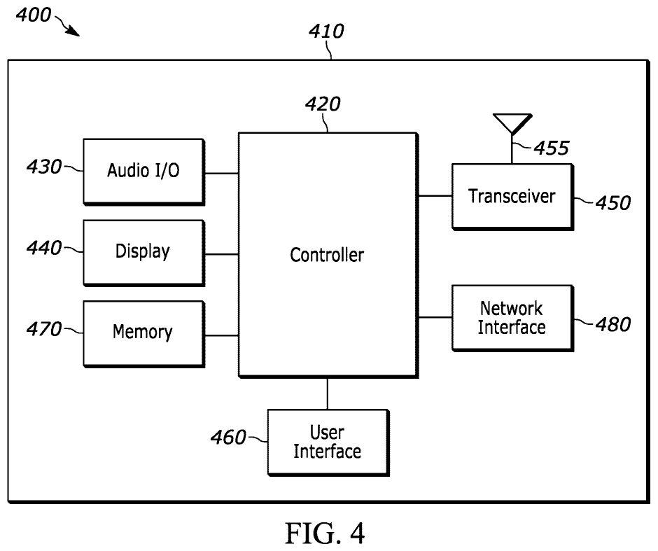

FIG. 4 is an example block diagram of an apparatus 400, such as the wireless communication device 110, according to a possible embodiment. The apparatus 400 can include a housing 410, a controller 420 within the housing 410, audio input and output circuitry 430 coupled to the controller 420, a display 440 coupled to the controller 420, a transceiver 450 coupled to the controller 420, an antenna 455 coupled to the transceiver 450, a user interface 460 coupled to the controller 420, a memory 470 coupled to the controller 420, and a network interface 480 coupled to the controller 420. The apparatus 400 can perform the methods described in all the embodiments.

The display 440 can be a viewfinder, a liquid crystal display (LCD), a light emitting diode (LED) display, a plasma display, a projection display, a touch screen, or any other device that displays information. The transceiver 450 can include a transmitter and/or a receiver. The audio input and output circuitry 430 can include a microphone, a speaker, a transducer, or any other audio input and output circuitry. The user interface 460 can include a keypad, a keyboard, buttons, a touch pad, a joystick, a touch screen display, another additional display, or any other device useful for providing an interface between a user and an electronic device. The network interface 480 can be a Universal Serial Bus (USB) port, an Ethernet port, an infrared transmitter/receiver, an IEEE 1394 port, a WLAN transceiver, or any other interface that can connect an apparatus to a network, device, or computer and that can transmit and receive data communication signals. The memory 470 can include a random access memory, a read only memory, an optical memory, a solid state memory, a flash memory, a removable memory, a hard drive, a cache, or any other memory that can be coupled to an apparatus.

The apparatus 400 or the controller 420 may implement any operating system, such as Microsoft Windows®, UNIXR, or LINUXR, Android™, or any other operating system. Apparatus operation software may be written in any programming language, such as C. C++, Java or Visual Basic, for example. Apparatus software may also run on an application framework, such as, for example, a Java® framework, a NETR framework, or any other application framework. The software and/or the operating system may be stored in the memory 470 or elsewhere on the apparatus 400. The apparatus 400 or the controller 420 may also use hardware to implement disclosed operations. For example, the controller 420 may be any programmable processor. Disclosed embodiments may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 420 may be any controller or processor device or devices capable of operating an apparatus and implementing the disclosed embodiments. Some or all of the additional elements of the apparatus 400 can also perform some or all of the operations of the disclosed embodiments.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising.” “including.” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The teams “including” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

1. A method performed by a user equipment (UE), the method comprising:
receiving a cross-link interference measurement configuration, wherein the cross-link interference measurement configuration includes at least one cross-link interference resource configuration, wherein a cross-link interference resource configuration of the at least one cross-link interference resource configuration includes a cross-link interference resource and an indication of a first number of spatial information; and
performing measurements on the cross-link interference resource based on the indication of the first number of spatial information.

2-16. (canceled)

17. A user equipment (UE) for wireless communication, comprising:
at least one memory; and
at least one processor coupled with the at least one memory and configured to cause the UE to:
receive a cross-link interference measurement configuration, wherein the cross-link interference measurement configuration includes at least one cross-link interference resource configuration, wherein a cross-link interference resource configuration of the at least one cross-link interference resource configuration includes a cross-link interference resource and an indication of a first number of spatial information; and
perform measurements on the cross-link interference resource based on the indication of the first number of spatial information.

18. The user equipment (UE) of claim 17, wherein each spatial information is associated with a reference serving cell of the cross-link interference resource, wherein the cross-link interference resource is determined based on at least one parameter of the reference serving cell, and wherein each spatial information comprises a synchronization signal/physical broadcast channel block, a transmission configuration indicator-state, or a channel state information-reference signal resource of the reference serving cell.

19. The user equipment (UE) of claim 17, wherein, to perform measurements, the at least one processor is configured to cause the UE to generate a same number of measurement results for the cross-link interference resource as the indication of the first number of spatial information, wherein each measurement result corresponds to a different respective one of the first number of spatial information.

20. The user equipment (UE) of claim 19, wherein each measurement result for the cross-link interference resource comprises an indication of the cross-link interference resource, a measurement quantity, and an indication of a corresponding different respective one of the first number of spatial information.

21. (canceled)

22. A base station for wireless communication, comprising:
at least one memory; and
at least one processor coupled with the at least one memory and configured to cause the base station to:
transmit a cross-link interference measurement configuration, wherein the cross-link interference measurement configuration includes at least one cross-link interference resource configuration, wherein a cross-link interference resource configuration of the at least one cross-link interference resource configuration includes a cross-link interference resource and an indication of a first number of spatial information;
transmit a cross-link interference report configuration associated with the cross-link interference measurement configuration; and
receive a measurement report based on the cross-link interference report configuration, which includes measurements performed on the cross-link interference resource based on the indication of the first number of spatial information.

23. The UE of claim 17, wherein the at least one processor is further configured to cause the UE to:
receive a cross-link interference report configuration associated with the cross-link interference measurement configuration; and
transmit a measurement report based on the cross-link interference report configuration.

24. The UE of claim 23, wherein the indication of the first number of spatial information, upon which the measurements are based, includes a first number of different spatial filters being used for interference measurements, which produce potentially different interference levels measured by the UE which can be included in the measurement report.

25. The UE of claim 24, wherein the cross-link interference report configuration comprises an indication of a second number of spatial information to be selected from the first number of spatial information, wherein the second number is less than or equal to the first number, and wherein the measurement report includes measurement results for the second number of spatial information for the cross-link interference resource.

26. The UE of claim 25, wherein the second number of spatial information to be selected from the first number of spatial information includes an indication of spatial information for which a corresponding measurement results had a highest amount of interference from the measurements performed relative to the first number of different spatial filters.

27. The UE of claim 23, wherein to transmit the measurement report, the at least one processor is configured to cause the UE to transmit the measurement report in a radio resource control message.

28. The UE of claim 23, wherein the measurement report includes periodic cross-link interference reporting.

29. The UE of claim 23, wherein the measurement report includes event triggered cross-link interference reporting.

30. The UE of claim 17, wherein the at least one processor is further configured to cause the UE to receive a set of spatial information corresponding to the first number of spatial information.

31. The UE of claim 17, wherein the at least one processor is further configured to cause the UE to select a set of spatial information corresponding to the first number of spatial information by selecting a best first number of spatial information from all of available possible spatial information, based upon a predefined selection criteria.

32. The UE of claim 31, wherein the predefined selection criteria corresponds to a selection of one or more synchronization signal/physical broadcast channel blocks having a highest reference signal received power.

33. The UE of claim 31, wherein the predefined selection criteria corresponds to a selection of one or more transmission configuration indicator states having a lowest transmission configuration indicator state identity.

34. A processor for wireless communication, comprising:
at least one controller coupled with at least one memory and configured to cause the processor to:
receive a cross-link interference measurement configuration, wherein the cross-link interference measurement configuration includes at least one cross-link interference resource configuration, wherein a cross-link interference resource configuration of the at least one cross-link interference resource configuration includes a cross-link interference resource and an indication of a first number of spatial information; and
perform measurements on the cross-link interference resource based on the indication of the first number of spatial information.

35. The processor of claim 34, wherein each spatial information is associated with a reference serving cell of the cross-link interference resource, wherein the cross-link interference resource is determined based on at least one parameter of the reference serving cell, and wherein each spatial information comprises a synchronization signal/physical broadcast channel block, a transmission configuration indicator-state, or a channel state information-reference signal resource of the reference serving cell.

36. The processor of claim 34, wherein, to perform measurements, the at least one controller is configured to cause the processor to generate a same number of measurement results for the cross-link interference resource as the indication of the first number of spatial information, wherein each measurement result corresponds to a different respective one of the first number of spatial information, and wherein each measurement result for the cross-link interference resource comprises an indication of the cross-link interference resource, a measurement quantity, and an indication of a corresponding different respective one of the first number of spatial information.
